(19) United States
(12) Patent Application Publication
(10) Pub. No.: US 2013/0342068 A1
(43) Pub. Date: Dec. 26, 2013

(54) MOTOR AND ELECTRIC EQUIPMENT USING SAME

(71) Applicants: Takashi Ogawa, Osaka (JP); Yuichi Yoshikawa, Osaka (JP); Ikuo Ozaki, Shiga (JP); Toshiyuki Tamamura, Shiga (JP); Hirokazu Yamauchi, Wakayama (JP)

(72) Inventors: Takashi Ogawa, Osaka (JP); Yuichi Yoshikawa, Osaka (JP); Ikuo Ozaki, Shiga (JP); Toshiyuki Tamamura, Shiga (JP); Hirokazu Yamauchi, Wakayama (JP)

(73) Assignee: PANASONIC CORPORATION, Kadoma-shi, Osaka (JP)

(21) Appl. No.: 13/983,255

(22) PCT Filed: Feb. 1, 2012
(86) PCT No.: PCT/JP2012/000667

§ 371 Date: Sep. 16, 2013

(30) Foreign Application Priority Data
Feb. 2, 2011 (JP) 2011-020347

(51) Int. Cl. H02K 1/12

(52) U.S. Cl. CPC H02K 1/12
USPC 310/216.001

(57) ABSTRACT

A plurality of protruding portions each having a predetermined width in a circumferential direction are respectively provided at a predetermined interval along an outer periphery of a stator, and through-holes are formed at both ends in the circumferential direction of the protruding portions. A total length of the widths, which the protruding portions respectively have, in the circumferential direction is set equal to or less than 25% of an outer circumference of the stator. With this structure and by virtue of the through-holes, a compressive stress built up in an inner periphery of the stator due to pressing forces imposed on center areas of the protruding portions can be distribute toward the outer periphery of the stator.

### TECHNICAL FIELD

The present invention relates to a structure of a stator in a motor.

### BACKGROUND ART

A motor of conventional type comprises a cylindrical casing, a cylindrical stator fixed to an inside of the casing by shrinkage of the casing, and a rotor accommodated rotatably in an inner periphery of the stator. The stator has a plurality of protruding portions provided around an outer periphery thereof at predetermined intervals along a circumferential direction, and each of the protruding portions has a predetermined width in the circumferential direction and through-holes provided at both ends thereof in the circumferential direction (refer to patent literature 1, for example).

FIG. 6 is an illustration showing a conventional motor described in patent literature 1. As shown in FIG. 6, the conventional motor comprises cylindrical casing 101, and stator 102 fixed to the inside of casing 101 by shrinkage of casing 101. Stator 102 has a plurality of protruding portions 108 formed along an outer periphery thereof at predetermined intervals in a circumferential direction, and each of protruding portions 108 has a predetermined width in the circumferential direction and through-holes 107 at both ends of protruding portion 108 in the circumferential direction.

The motor of this kind has hitherto had a problem that an iron loss increases due to degradation in magnetic property of the magnetic body that composes the stator, because of a compressive stress built up in the stator due to heat shrinkage of the cylindrical casing when the stator disposed inside the casing is fixed by means of shrink fitting or the like method.

For this reason, a structure of the motor described in patent literature 1 is provided with through-holes 107 at both ends of protruding portion 108 formed along the outer periphery of stator 102, and the compressive stress built up in the inner periphery of stator 102 is reduced by making through-holes 107 deform to absorb a pressing force to stator 102 attributed to the heat shrinkage of casing 101.

In the structure discussed above, however, the pressing force to stator 102 attributed to the heat shrinkage of casing 101 cannot be absorbed in a center area of protruding portion 108, although the compressive stress built up in the inner periphery of stator 102 can be reduced by through-holes 107 at both the ends of protruding portion 108. It thus has the problem that an iron loss occurs due to the compressive stress built up in the inner periphery of stator 102.

PTL 1: Unexamined Japanese Patent Publication No. 2009-261058

NPL 1: The Institute of Electrical Engineers of Japan, IEEJ Transactions on Industry Applications (D) Vol. 127, No.1, P60-P68

### SUMMARY OF THE INVENTION

A motor of the present invention comprises a cylindrical casing, a cylindrical stator fixed to an inside of the casing by shrinkage of the casing, and a rotor accommodated rotatably in an inner periphery of the stator. The stator has a plurality of protruding portions provided around an outer periphery thereof at predetermined intervals along a circumferential direction, and each of the protruding portions has a predetermined width in the circumferential direction, and through-holes provided at both ends thereof in the circumferential direction. A total length of the widths of the protruding portions in the circumferential direction is equal to or less than 25% of an outer circumference of the stator.

As a result, this structure can reduce a compressive stress built up in the inner periphery of the stator by making the through-holes deform at both the ends of the protruding portions to absorb a pressing force to the stator. In addition, the structure also helps reduce the compressive stress built up in the inner periphery of the stator by distributing the compressive stress in center areas of the protruding portions toward the outer periphery of the stator by virtue of positional arrangement of the through-holes.

According to the present invention, the compressive stress produced in the inner periphery of the stator can be reduced by distributing the compressive stress produced in the stator due to shrink fitting and the like to the outer periphery of the stator, thereby reducing an iron loss and achieving the motor of high efficiency.

### BRIEF DESCRIPTION OF THE DRAWINGS

FIG. 1 is a partial sectional view of a motor according to first exemplary embodiment of the present invention.

FIG. 2 is a graphic representation showing a relationship between ratio of total length of widths of protruding portions in a circumferential direction to an outer circumference of a stator and compressive stress acting on an inner periphery of the stator.

FIG. 3 is a graphic representation showing a relationship between stress built up in a magnetic body and iron loss.

FIG. 4 is a cross sectional view of the motor according to the first embodiment of the present invention wherein a center of a protruding portion in the circumferential direction is aligned with a center of a slot in the circumferential direction.

FIG. 5 is a longitudinal sectional view showing a structure of a compressor equipped with the motor in the first embodiment of the present invention.

FIG. 6 is a cross sectional view of a conventional motor.

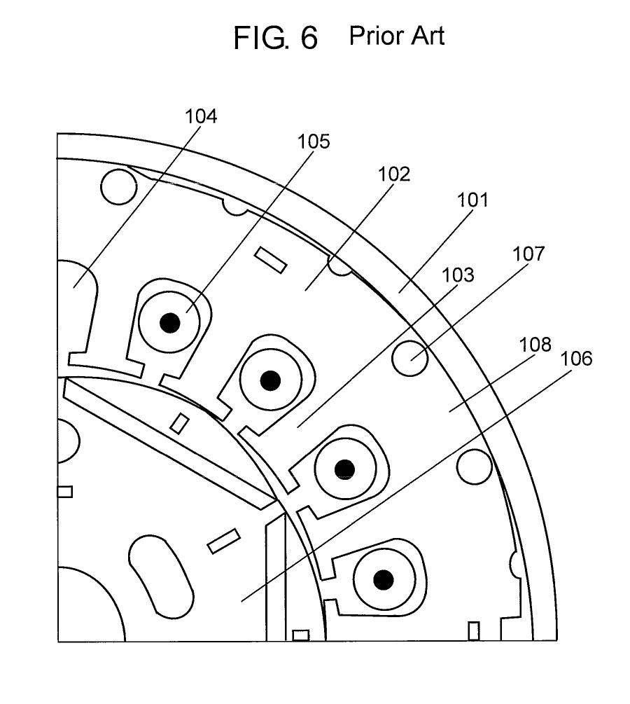

### DETAILED DESCRIPTION OF THE PREFERRED EMBODIMENT

Description will be provided hereinafter of an exemplary embodiment of the present invention with reference to the accompanying drawings. However, the embodiment described herein is not intended to limit the scope of the present invention.

### First Exemplary Embodiment

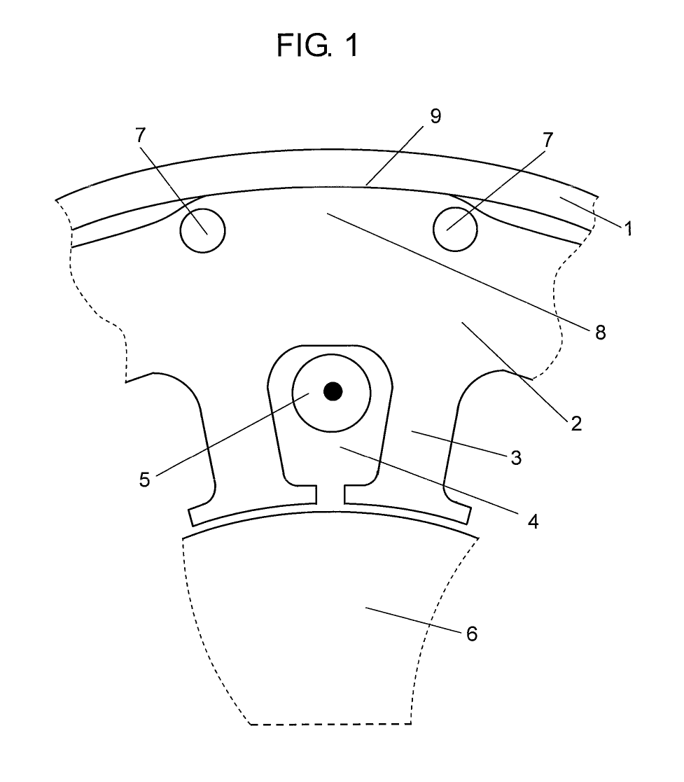

FIG. 1 is a partial sectional view of a motor according to the first exemplary embodiment of the present invention. In FIG. 1, the motor of this embodiment comprises cylindrical casing 1, cylindrical stator 2 fixed to an inside of casing 1 by shrinkage of casing 1, teeth 3 formed to protrude on an inner peripheral side of stator 2 and respectively arranged at a predetermined interval along a circumferential direction, winding 5 disposed to slot 4 formed between adjoining two of teeth 3, and rotor 6 accommodated rotatably into a place facing teeth 3 at an inner peripheral side of teeth 3. Stator 2 is provided with a plurality of protruding portions 8 respectively having a predetermined width in the circumferential direction, and disposed at a predetermined interval along an outer periphery thereof. Each of protruding portions 8 is provided with through-holes 7 at both ends thereof in the circumferential direction. A total length of the widths of protruding portions 8 in the circumferential direction is equal to or less than 25% of an outer circumference of stator 2. In other words, a total length of widths in the circumferential direction of contacting surfaces 9 of protruding portions 8 that are in contact with the inner periphery of casing 1 is equal to or less than 25% of the outer circumference of stator 2.

The motor constructed as above operates and functions in a manner which is described hereinafter.

The motor of this kind is subjected to shrink fitting for fixing the stator to the casing, which mainly uses heat shrinkage of the cylindrical casing to fix the stator. During this process, magnetic property of a magnetic body composing the stator degrades because of a compressive stress built up in the stator due to the heat shrinkage of the casing, thereby giving rise to an increase in iron loss. The structure hitherto adopted is to reduce the compressive stress built up in the inner periphery of the stator by providing through-holes at both ends of protruding portions formed along the outer periphery of the stator and making the through-holes deform and absorb a pressing force to the stator at both the ends of the protruding portions. In the case of the stator having such a structure, however, the compressive stress remains to exist in the inner periphery of the stator since the pressing force to the stator due to the heat shrinkage of the casing cannot be absorbed in a center area of the protruding portion.

The motor of this exemplary embodiment is so configured that a total length of the widths of protruding portions 8 in the circumferential direction becomes equal to or less than 25% of the outer circumference of stator 2. With this structure, the pressing force to stator 2 is absorbed by deformation of through-holes 7 at both the ends of protruding portions 8. As a result, the compressive stress built up in stator 2 can be reduced. In addition, the structure can distribute the compressive stress in the center areas of protruding portions 8 toward the outer periphery of stator 2 by virtue of positional arrangement of the through-holes. It thus becomes possible to reduce the compressive stress acting on the inner periphery of stator 2, suppress degradation of the magnetic property of stator 2, and prevent an increase in the iron loss.

Described next is a result of the study conducted for verification of the effectiveness of this exemplary embodiment. Compressive stresses built up in the inner periphery of teeth 3 are calculated by analyzing the compressive stresses while making changes in the ratio of total length of the widths of protruding portions 8 in the circumferential direction to the outer circumference of stator 2.

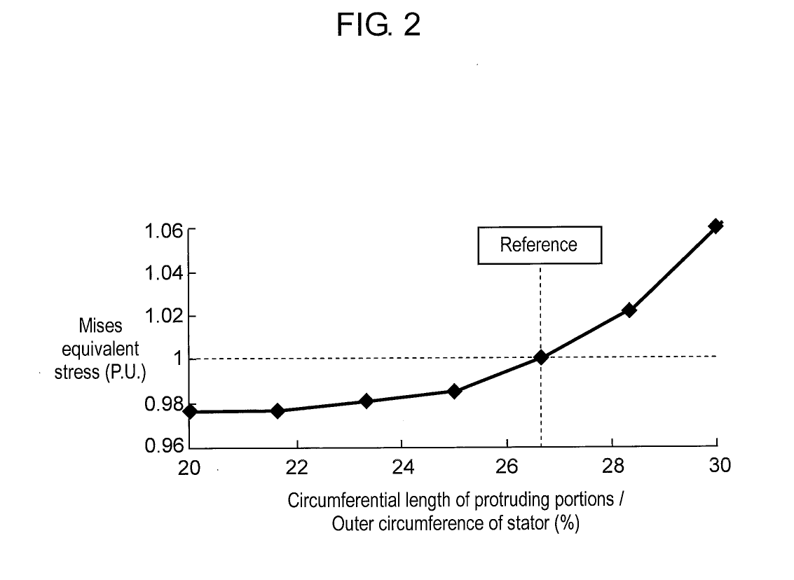

FIG. 2 shows a relationship between the ratio of total length of widths of protruding portions 8 in a circumferential direction to the outer circumference of stator 2 and compressive stress acting on an inner periphery of teeth 3.

For the purpose of comparison, a reference value set at this time is a compressive stress built up in stator 2 when the total length of the widths of protruding portions 8 in the circumferential direction is 27% in the ratio to the outer circumference of stator 2, and variations in value of the compressive stress are shown when the total length of the widths of protruding portions 8 in the circumferential direction to the outer circumference of stator 2 is changed with respect to the reference value. It can be verified that the compressive stress that acts on the inner periphery of stator 2 decreases by 2% when the ratio of the total length of the widths of protruding portions 8 in the circumferential direction to the outer circumference of stator 2 is set to 25% or less according to this embodiment.

Further study is made of the effectiveness of reducing the stress upon suppression of the iron loss, according to the relationship between stress built up in magnetic body and iron loss, which is shown in non-patent literature 1.

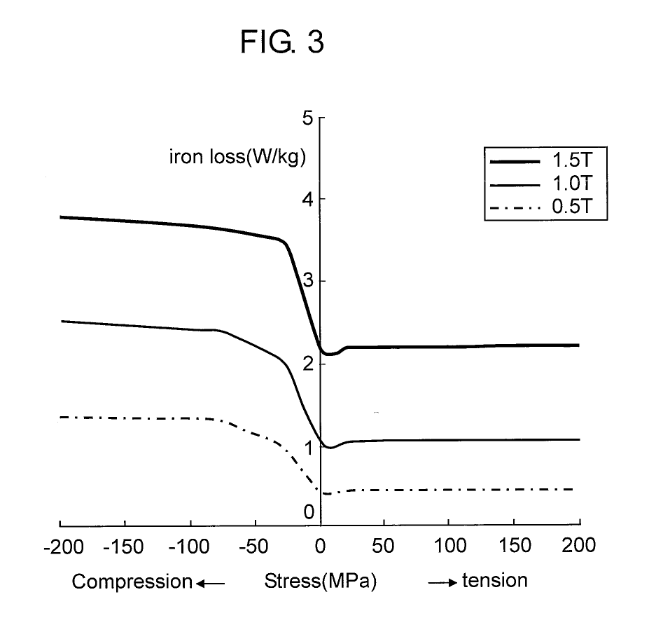

FIG. 3 is a graphic representation showing the relationship between the stress built up in a magnetic body and iron loss. In FIG. 3, the horizontal axis represents the stress built up in a magnetic body, and the vertical axis represents the iron loss produced in the magnetic body. The stress built up in the magnetic body is classified into a compressive stress and a tensile stress. The iron loss of a magnetic body increases substantially with a compression of 30 MPa, but the iron loss increases gradually beyond this value of the compression. It is because of this relationship that can decrease the compressive stress acting on the inner periphery of stator 2 by 2%, and suppress the iron loss produced in the inner periphery of stator 2 that constitutes a primary magnetic circuit in this exemplary embodiment.

According to this exemplary embodiment, as discussed above, stator 2 is provided with the plurality of protruding portions 8 respectively having the predetermined width in the circumferential direction, and disposed at a predetermined interval along the outer periphery thereof, and that each of protruding portions 8 is provided with through-holes at both ends thereof in the circumferential direction. The total length of the widths, which the plurality of protruding portions 8 respectively have, in the circumferential direction is set equal to or less than 25% of the outer circumference of stator 2. As a result, this reduces the compressive stress built up in stator 2 by making through-holes 7 deform at both the ends of protruding portions 8 and absorb the pressing force to stator 2. In addition, the positional arrangement of through-holes 7 also can distribute the compressive stress in the center areas of individual protruding portions 8 toward the outer periphery of stator 2. The structure can hence reduce the compressive stress built up in the inner periphery of stator 2, suppress degradation of the magnetic property of the magnetic body that constitutes stator 2, and prevent an increase in the iron loss.

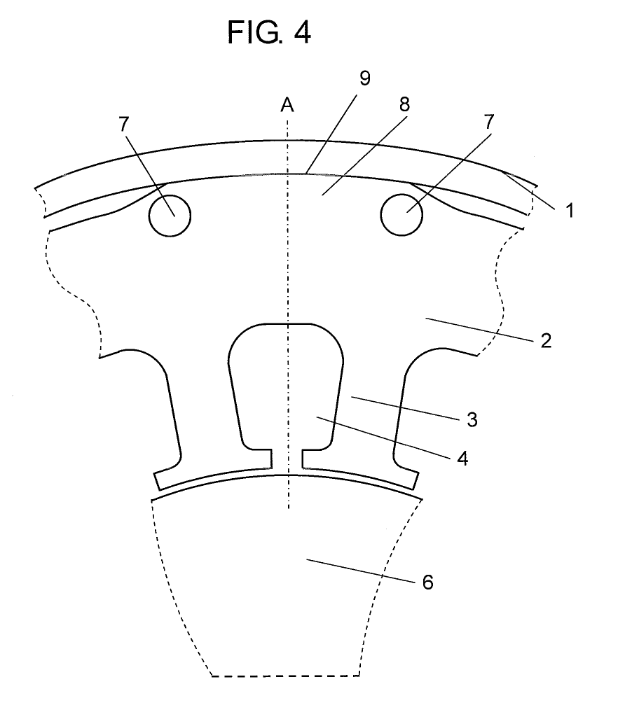

In this exemplary embodiment, the protruding portions may be so provided that their centers in the circumferential direction are aligned individually with centers in the circumferential direction of the corresponding slots, and that the protruding portions are formed respectively on the outer peripheral side of the slots. This structure can divert the compressive stress distributed at the centers of the protruding portions toward peripheral side of teeth that do not constitute the main magnetic circuit. FIG. 4 is a cross sectional view of the motor of which the circumferential centers of the protruding portions are aligned with the circumferential centers of their corresponding slots, according to the first exemplary embodiment of the invention. In FIG. 4, center line A passes through the center of stator 2 and extends in a radial direction, and both the circumferential center of protruding portion 8 and the circumferential center of slot 4 lie on center line A. This configuration can also suppress increase in the iron loss since a magnetic flux that flows in the peripheral side of the teeth is insignificant even if degradation occurs in the magnetic property due to the compressive stress.

Furthermore, the pressing force imposed on each of protruding portions 8 of stator 2 can be reduced by having the number of protruding portions 8 in this embodiment equal to or larger than the number of the slots. Accordingly, degradation of the magnetic property of the magnetic body can be suppressed around the inner periphery of stator 2 by distributing the compressive stress built up in stator 2, thereby suppressing any increase in the iron loss.

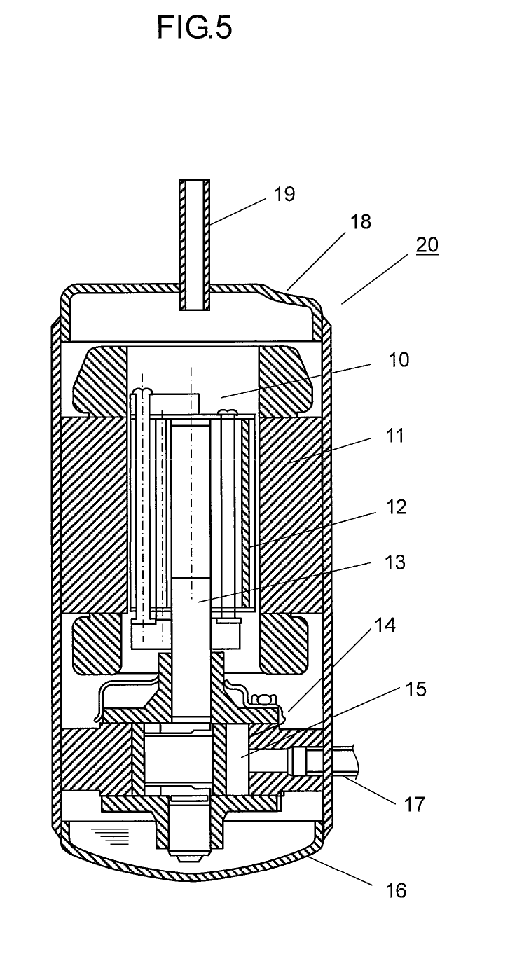

Description provided next is an example in which the motor of this exemplary embodiment is used in a compressor to be mounted to an apparatus such as an air conditioner. FIG. 5 is a longitudinal sectional view showing a structure of the compressor equipped with the motor of this exemplary embodiment. As shown in FIG. 5, compressor 20 has a hermetically-sealed container constructed of cap A 16 and cap B 18 of disc-like shape welded to top and bottom openings of a cylindrical casing. A compressor unit and motor 10 are disposed to a lower section and an upper section in the casing respectively. The compressor unit is so constructed that rotor 15 is disposed in an eccentric position inside cylinder 14. Refrigerant is suctioned through tube A 17 and compressed inside cylinder 14 when rotor 15 is rotated with cylindrical shaft 13. The compressed refrigerant is ejected into a space inside the casing above the motor by passing through shaft 13 and between stator 11 and rotor 12 of motor 10. Lubricant (oil) is contained in lower cap A 16. Therefore, the lubricant is ejected into the space inside the casing above motor 10 by the rotation of rotor 12 in the same manner as the refrigerant. However, the lubricant drips down by the weight of its own after it reaches above motor 10 in the casing and circulates into lower cap A 16 because the lubricant has a larger specific gravity than the refrigerant. As a result, only the compressed refrigerant is discharged from tube B 19.

The motor of this embodiment, when used as shown in a compressor mounted to an air conditioner and the like equipment, for instance, is capable of contributing to an improvement of the efficiency of the equipment.

As illustrated above, the motor of the present invention comprises a cylindrical casing, a cylindrical stator fixed to the inside of the casing by shrinkage of the casing, teeth formed to protrude on an inner peripheral side of the stator and respectively arranged at a predetermined interval along a circumferential direction, a winding disposed to a slot formed between adjoining two of the teeth, and a rotor accommodated rotatably in a place facing the teeth at an inner peripheral side of the teeth. The stator has a plurality of protruding portions having a predetermined width in the circumferential direction, and respectively disposed at a predetermined interval along an outer periphery of the stator. Each of the protruding portions is provided with through-holes at both ends thereof in the circumferential direction. A total length of the widths of the protruding portions in the circumferential direction is set equal to or less than 25% of an outer circumference of the stator.

The above structure can distribute a compressive stress built up in center areas of the protruding portions due to a pressing force to the stator by shrinkage of the casing toward the outer periphery of the stator, by virtue of the through-holes provided at both the ends of the protruding portions. The structure is thus capable of reducing the compressive stress built up in the inner periphery of the stator, and preventing increase in the iron loss.

The motor of the present invention has the protruding portions so provided that their centers in the circumferential direction are aligned individually with centers in the circumferential direction of the corresponding slots, and that the protruding portions are formed on the outer peripheral side of the slots. This structure can divert the compressive stress distributed at the centers of the protruding portions toward the peripheral side of the teeth. Since the peripheral side of the teeth has an insignificant influence to the main magnetic circuit, the structure can suppress the increase in iron loss even if degradation occurs in the magnetic property as a result of the compressive stress.

Furthermore, the motor of the present invention reduces the pressing force of the casing imposed upon each of the protruding portions by making the number of the protruding portions equal to or larger than the number of the slots and increasing locations where the casing is in contact with the stator. This structure can also suppress the increase in the iron loss since it can distribute the compressive stress built up in the stator.

In addition, the electric equipment of the present invention has an advantage of suppressing an iron loss attributable to the compressive stress when the above motor of the present invention is used for a compressor mounted to an air-conditioner, for instance, thereby helping to compose a highly efficient motor.

### INDUSTRIAL APPLICABILITY

The motor according to the present invention is useful for such an apparatus as a compressor for air-conditioning equipment, in which the stator is fixed to the casing by shrink fitting, since it is capable of reducing a compressive stress of the casing that acts on an inner periphery of the stator during the shrink fitting and the like process.

### REFERENCE MARKS IN THE DRAWINGS

1, 101 casing
2, 102 stator
3, 103 tooth
4, 104 slot
5, 105 winding
6, 106 rotor
7, 107 through-hole
8, 108 protruding portion
9 contacting surface
10 motor
20 compressor
A center line

1. A motor comprising:
a cylindrical casing;
a cylindrical stator fixed to an inside of the casing by shrinkage of the casing;
teeth formed to protrude on an inner peripheral side of the stator and arranged respectively at a predetermined interval along a circumferential direction of the stator;
a winding disposed to a slot formed between adjoining two of the teeth; and
a rotor accommodated rotatably in a place facing the teeth at an inner peripheral side of the teeth,
wherein
the stator is provided with a plurality of protruding portions respectively having a predetermined width in the circumferential direction, and disposed at a predetermined interval along an outer periphery of the stator,
each of the protruding portions has through-holes at both ends thereof in the circumferential direction, and
a total length of the widths, which the protruding portions respectively have, in the circumferential direction is equal to or less than 25% of an outer circumference of the stator.

2. The motor of claim 1, wherein the protruding portions are provided on an outer peripheral side of the slots with a circumferential center of each of the protruding portions aligned with a circumferential center of corresponding one of the slots.

3. The motor of claim 1, wherein a number of the protruding portions provided is equal to or larger than a number of the slots.

4. Electric equipment equipped with the motor of claim 1.

5. The motor of claim 2, wherein a number of the protruding portions provided is equal to or larger than a number of the slots.
